(19) United States
(12) Patent Application Publication
(10) Pub. No.: US 2006/0038081 A1
(43) Pub. Date: Feb. 23, 2006

(54) Electric dipole spacecraft

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 10/912,621

(22) Filed: Aug. 4, 2004

(51) Int. Cl. B64G 1/40

(52) U.S. Cl. 244/171.5

(57) ABSTRACT

This invention is a rotating spacecraft that produces an electric dipole on four rotating spherical conducting domes perturbing a uniform spherical electric field to create a magnetic moment interacting with the gradient of a magnetic field that generates a lift force on the hull.

### BRIEF SUMMARY OF THE INVENTION

This invention is a rotating spacecraft that utilizes four spherical conducting domes perturbing a uniform electric field in order to create a lift force by means of a magnetic moment times the gradient of a magnetic field.

### BACKGROUND OF THE INVENTION

An electric dipole p is two electrical charges of opposite sign {q, −q} separated by a distance a.
p=qa=coulomb·meter

If this dipole is moving with a velocity v, it produces a magnetic moment μ.

$$μ = pv = qav = coulomb meter \frac{meter}{sec} = \frac{coulomb}{sec} {meter}^{2} = IArea$$

The magnetic moment is equal to a current I circulating around an area. The magnetic field B has units of kilogram per second per charge coulomb.

$$B = \frac{kg}{sec coul}$$

The gradient of the magnetic field in the vertical direction z has units of

$$\frac{dB}{dz} = \frac{kg}{sec coul meter}$$

This gradient interacting with a magnetic moment creates a force F measured in newtons.

$${F}_{z} = μ \frac{dB}{dz} = \frac{coul {m}^{2}}{sec} \frac{kg}{sec coul m} = \frac{kg m}{{sec}^{2}} = newton$$

In terms of vectors, the force is equal to
F=∇(μ·B)
which is the gradient ∇ of the dot product (·) of the magnetic moment with the magnetic field. This means that the magnetic moment has to be aligned with the field. The lift force on the spacecraft would then be the magnetic moment in the vertical z-direction μ_{z} times the magnetic field in the z-direction B_{z}. For constant magnetic moment, the gradient affects the magnetic field only, resulting in the same force equation
F_{z}=∇(μ_{z}·B_{z})=μ_{z}∇B_{z}

Referring to FIG. 1, the electric dipole has a positive charge q located on the z-axis at a distance a from the origin of the graph. A second negative charge −q is located at a distance −a from the origin. The positive charge produces an electrostatic potential φ₁ at a radius r₁ equal to the charge q divided by 4π times the permittivity of space ε₀

$${φ}_{1} = \frac{q}{4 {πɛ}_{0}} \frac{1}{{r}_{1}}$$

where the permittivity is linear capacitance, measured in farads per meter. The electrostatic potential has units of volts

$$φ = \frac{coul}{( \frac{farad}{meter} )} \frac{1}{meter} = \frac{coul}{farad} = volt$$

because the charge in coulombs held by a capacitor is equal to the capacitance, measured in farads, times the capacitor voltage. Because the second charge has the opposite sign, the potential φ₂ at a radius r₂ to the same point in space is

$${φ}_{2} = \frac{- q}{4 {πɛ}_{0}} \frac{1}{{r}_{2}}$$

The total potential φ at some point in space is equal to the sum of the two potentials, or

$$φ = {φ}_{1} + {φ}_{2} = \frac{q}{4 {πɛ}_{0} {r}_{1}} - \frac{q}{4 {πɛ}_{0} {r}_{2}} = \frac{q}{4 {πɛ}_{0}} [ \frac{1}{{r}_{1}} - \frac{1}{{r}_{2}} ]$$

As seen in the diagram, the point of space is a distance r from the origin. Using the law of cosines, radius r₁ can be written as

$${r}_{1} = {( {r}^{2} + {a}^{2} - 2 ar cos ( θ ) )}^{\frac{1}{2}} = {r ( 1 + {( \frac{a}{r} )}^{2} - 2 ( \frac{a}{r} ) cos ( θ ) )}^{\frac{1}{2}} = {r ( 1 - 2 xt + {t}^{2} )}^{\frac{1}{2}}$$

where t is the ratio of the charge location over the radius, and x is cos(θ). The potential for positive charge q₁ can be written

$${φ}_{1} = \frac{q}{4 {πɛ}_{0}} \frac{1}{{r}_{1}} = \frac{q}{4 {πɛ}_{0}} \frac{1}{r} {( 1 - 2 xt + {t}^{2} )}^{- 1 / 2}$$

Dropping the factor q/4πε₀r, the square root can be expressed in terms of the Legendre polynomial Pₙ cos(θ) of the nth power

$$g ( t , x ) = {( 1 - 2 xt + {t}^{2} )}^{- 1 / 2} = {\sum }_{n = 0}^{∞} {P}_{n} ( x ) {t}^{n}$$

where the absolute value of t is less than one. The polynomial coefficients of tⁿ can be obtained by using the binomial theorem to expand the generating function g(t,x) as

$${( 1 - 2 xt + {t}^{2} )}^{- 1 / 2} = {\sum }_{n = 0}^{∞} \frac{( 2 n ) !}{{2}^{2 n} {( n ! )}^{2}} {( 2 xt - {t}^{2} )}^{n}$$

which evaluates to

$$\frac{0 !}{{2}^{0} {( 0 ! )}^{2}} {( 2 xt - {t}^{2} )}^{0} + \frac{2 !}{{2}^{2} {( 1 ! )}^{2}} {( 2 xt - {t}^{2} )}^{1} + \frac{4 !}{{2}^{4} {( 2 ! )}^{2}} {( 2 xt - {t}^{2} )}^{2}$$

$$1 {t}^{0} + {xt}^{1} + ( \frac{3}{2} {x}^{2} - \frac{1}{2} ) {t}^{2} + order ( {t}^{3} )$$

The first three Legendre polynomials are therefore

$${P}_{0} = 1$$

$${P}_{1} = x$$

$${P}_{2} = \frac{1}{2} ( 3 {x}^{2} - 1 )$$

The electrostatic potential for both charges of the electric dipole is

$$φ = \frac{q}{4 {πɛ}_{0}} \frac{1}{r} \{ {( 1 - 2 ( \frac{a}{r} ) cos ( θ ) + {( \frac{a}{r} )}^{2} )}^{- 1 / 2} - {( 1 + 2 ( \frac{a}{r} ) cos ( θ ) + {( \frac{a}{r} )}^{2} )}^{- 1 / 2} \}$$

The potential can be evaluated in terms of the Legendre polynomials as

$$\begin{matrix}φ = \frac{q}{4 {πɛ}_{0} r} [ {\sum }_{n = 0}^{∞} {P}_{n} ( cos ( θ ) ) {( \frac{a}{r} )}^{n} - {\sum }_{n = 0}^{∞} {P}_{n} ( cos ( θ ) ) {( - 1 )}^{n} {( \frac{a}{r} )}^{n} ] \\ = \frac{2 q}{4 {πɛ}_{0} r} [ {P}_{1} ( cos ( θ ) ) ( \frac{a}{r} ) + {P}_{3} ( cos ( θ ) ) {( \frac{a}{r} )}^{3} + … ]\end{matrix}$$

The first and most dominant term when the radius is much greater than location a is equal to

$$φ = \frac{2 aq}{4 {πɛ}_{0}} \frac{{P}_{1} ( cos ( θ ) 0}{{r}^{2}}$$

which is the electric dipole potential and 2aq is the dipole moment
p=2aq

Now imagine a constant electric field E₀ which is perturbed by a conducting sphere of radius a. The unperturbed electrostatic potential outside the sphere would the negative of the electric field times the radius times the Legendre polynomial, or
φ₁=−E₀rP₁

The electrostatic potential perturbed by the charges is the voltage E₀a times the radius a times the a of the dipole moment times the Legendre polynomial divided by the radius squared

$${φ}_{2} = {E}_{0} aaa \frac{{P}_{1}}{{r}^{2}} = {E}_{0} {a}^{3} \frac{{P}_{1}}{{r}^{2}}$$

The total potential outside the sphere is the sum of the two potentials equal to

$$φ = - {E}_{0} {rP}_{1} + {E}_{0} {a}^{3} \frac{{P}_{1}}{{r}^{2}} = - {E}_{0} {P}_{1} ( r - \frac{{a}^{3}}{{r}^{2}} ) = - {E}_{0} {rP}_{1} ( 1 - {( \frac{a}{r} )}^{3} )$$

Referring to FIG. 2, the previously uniform electric field is shown perturbed by the neutral conducting sphere. The center of the sphere is taken as the origin and the z-axis is oriented parallel to the original uniform field.

The electric field induces a surface charge density σ on the sphere equal to the negative of the permittivity of space times the gradient of the electrostatic potential

$$σ = - {ɛ}_{0} \frac{\partial φ}{\partial r} {\vert}_{r = a} = 3 {ɛ}_{0} {E}_{0} cos ( θ )$$

The electric field also induces an electric dipole moment on the sphere equal to the

$$p = \frac{qa}{r} \cdot \frac{2 {a}^{2}}{r} = 4 {πɛ}_{0} {E}_{0} {a}^{3}$$

with units of coulomb-meter. If this sphere is rotating around a central axis at a velocity v, it will create a magnetic moment μ equal to the dipole moment times the velocity.
μ=pv
with units of ampere-meter².

### SUMMARY OF THE INVENTION

As shown in the preceding background section, a neutral conducting sphere placed in a uniform electric field will generate a magnetic moment when rotated around a central axis. The electric field can be created by two points charges of opposite sign separated by a distance between them.

Referring to FIG. 3, the spacecraft has a spherical cabin (A) to which are attached cone-shaped electrostatic towers (B,C) above and below the cabin along the direction of travel in the z-direction. Because the electric field goes from the positive charge to the negative charge, the tip of the lower tower has a positively charged electrode, and the upper tower has a negatively charged electrode. Four equally-spaced neutral conducting spheres (D) are connected to the cabin by non-conducting tubes (E). The tubes make an angle with the cabin such that the distance (CD) is greater than distance (DB). The angle θ of the tube with respect to the cabin can be seen in side view FIG. 4.

Referring to FIG. 5, the charges create a uniform spherical field between the towers. The conducting spheres perturb this field such that the electric field (E) points toward the upper tower in a manner similar to that shown previously in FIG. 2.

Referring to FIG. 6, the conducting sphere produces an electric dipole moment (A) pointing at an angle toward the upper tower.

Referring to FIG. 7, by the law of addition of vectors, the electric dipole \overline{p} can be represented by two orthogonal vectors pointing in the vertical z-direction p_{z} and in the inward radial direction pᵣ.

Referring to FIG. 8, the hollow tube (A) connecting the cabin with the conducting sphere contains a spiral-wound electrical solenoid (B) which produces a magnetic field (C). This magnetic field \overline{B} can be decomposed into two orthogonal vectors pointing in the vertical z-direction B_{z} and in the outward radial direction Bᵣ as shown in FIG. 9.

Referring to top-view FIG. 10, the spacecraft has a clockwise angular velocity ω (A) which gives the conducting sphere a velocity v as shown by the vector (B). By the right-hand rule of physics, the angular velocity vector points in the negative z-direction. The angular velocity in the z-direction crossed with the radius r in the radial direction produces a velocity v in the clockwise θ-direction using cylindrical coordinates {r,θ,z}.
v_{θ}=w_{z}×rᵣ=−ωr

Referring to FIG. 11, the negative radial dipole moment pᵣ crossed with the negative velocity v_{θ} of the sphere produces a positive magnetic moment μ_{z} in the z-direction.
μ_{z}=pᵣ×v_{θ}=(−pᵣ)(−v_{θ})=pv

Referring to FIG. 12, the magnetic field B_{z} in the vertical z-direction is dotted with the magnetic moment μ_{z} in the z-direction to produce a force F_{z} in the vertical z-direction on each conducting sphere (FIG. 13).
F_{z}=∇(μ_{z}·B_{z})=μ_{z}∇B_{z}

The magnetic field that is produced by the solenoid actually curves away and around. Thus there is a gradient of the field in the z-direction.

The force can also be expressed in tensor notation. The magnetic B field in the vertical direction is part of an electromagnetic 4×4 matrix Faraday tensor F

$$β = t r θ z$$

$${F}_{β}^{α} = \begin{matrix}α = t & 0 & 0 & 0 & 0 & \\ α = r & 0 & 0 & {B}_{z} & 0 & \\ α = θ & 0 & - {B}_{z} & 0 & 0 & \\ α = z & 0 & 0 & 0 & 0 & \end{matrix}$$

which shows that the magnetic field is located in slot F^{r}_{θ} of the Faraday tensor. In tensor notation the subscripts and superscripts have to match up on both sides of the equation. Matching subscripts and superscripts on the same side of the equation cancel. In this case, the electric dipole moment is in the radial direction pᵣ. The velocity can be represented as a time derivative of the θ-coordinate x^{θ} or

$${v}^{θ} = \frac{\partial xθ}{\partial t}$$

Thus the force component in the z-direction becomes

$${F}_{z} = {p}_{r} {v}^{θ} {F}_{θ , z}^{r} = ( - p ) ( - v ) \frac{\partial {B}_{z}}{\partial z} = pv \frac{\partial {B}_{z}}{\partial z}$$

where the angular and radial tensor components cancel and comma-z (, z) represents differentiation of the magnetic field in the z-direction.

The spacecraft design also has an inherent motion control system for moving in various directions. If the magnetic field of one solenoid arm is increased or decreased, the force on that sphere will be increased or decreased. Thus the spacecraft can turn in a particular direction.

### A BRIEF DESCRIPTION OF THE DRAWINGS

FIG. 1. Electric dipole.

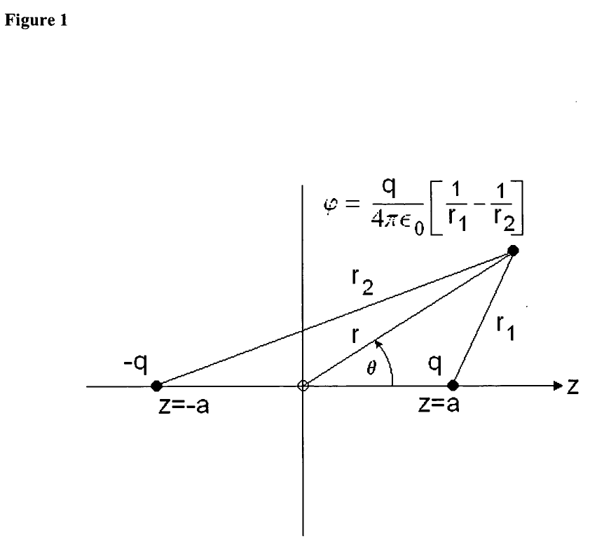

FIG. 2. Uniform electric field perturbed by electric dipole.

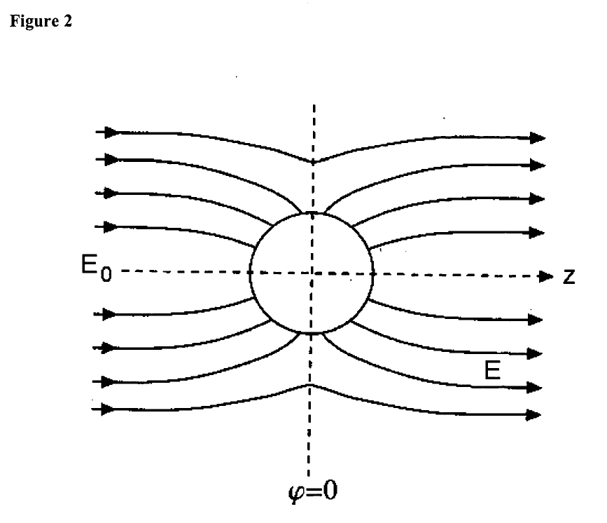

FIG. 3. Perspective view of spacecraft.

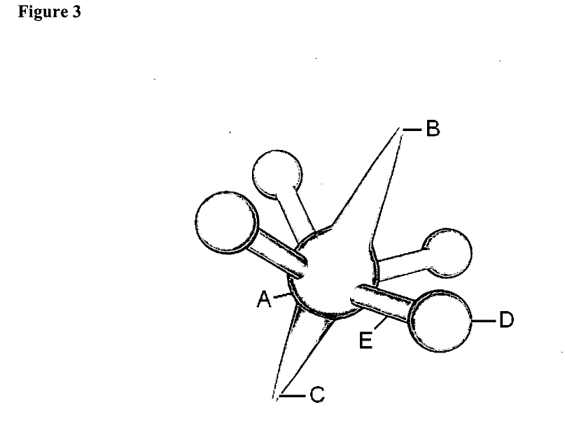

FIG. 4. Angle of solenoid tube.

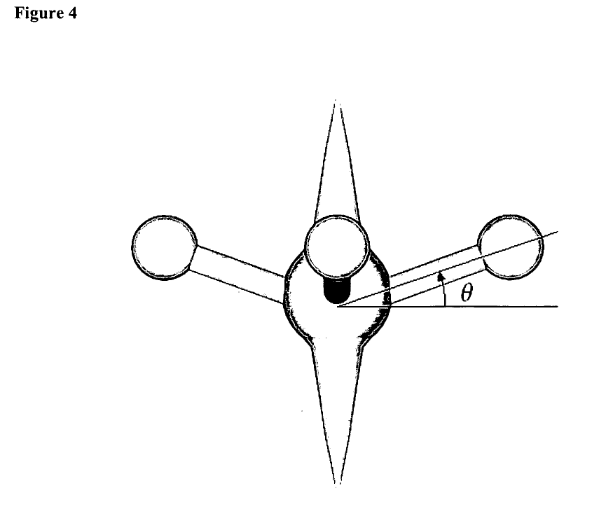

FIG. 5. Electric field perturbed by conducting sphere.

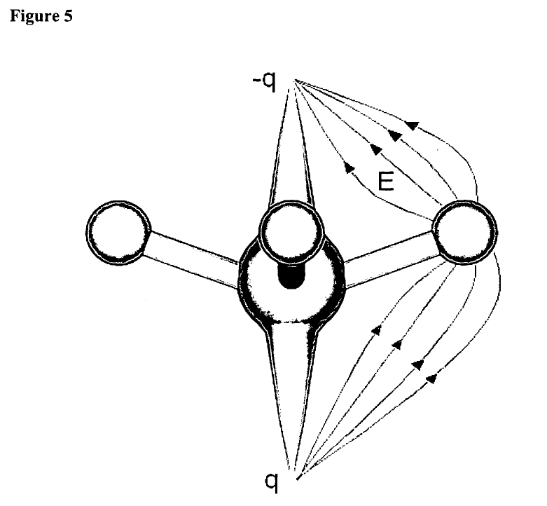

FIG. 6. Electric dipole generated by conducting sphere.

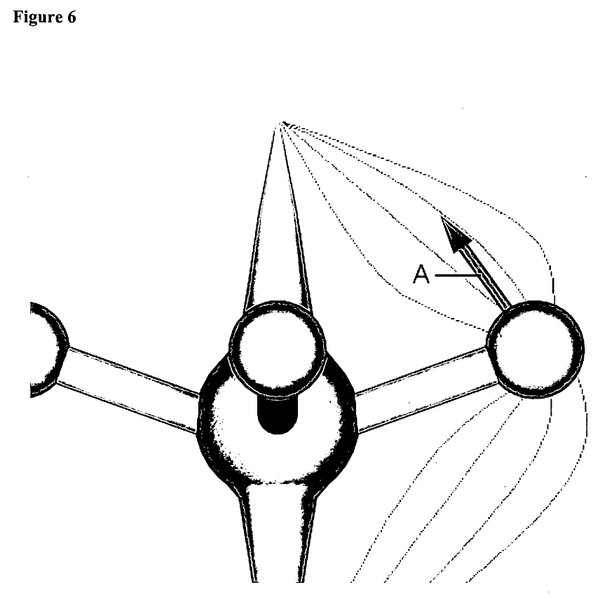

FIG. 7. Orthogonal vector components of electric dipole.

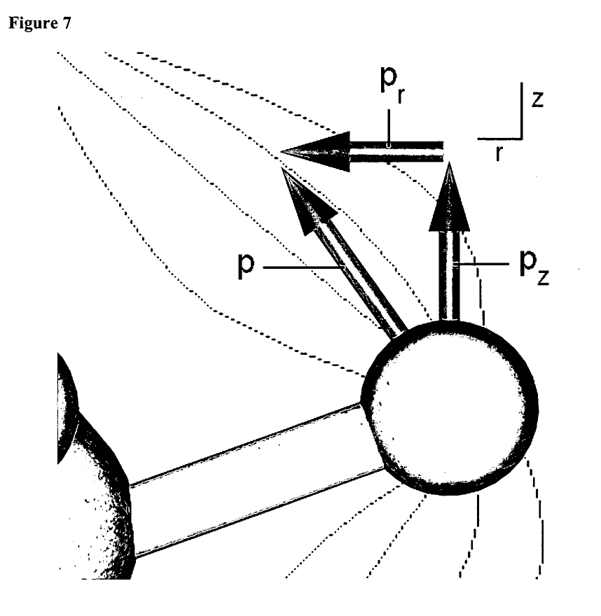

FIG. 8. Magnetic field produced by tube arm solenoid.

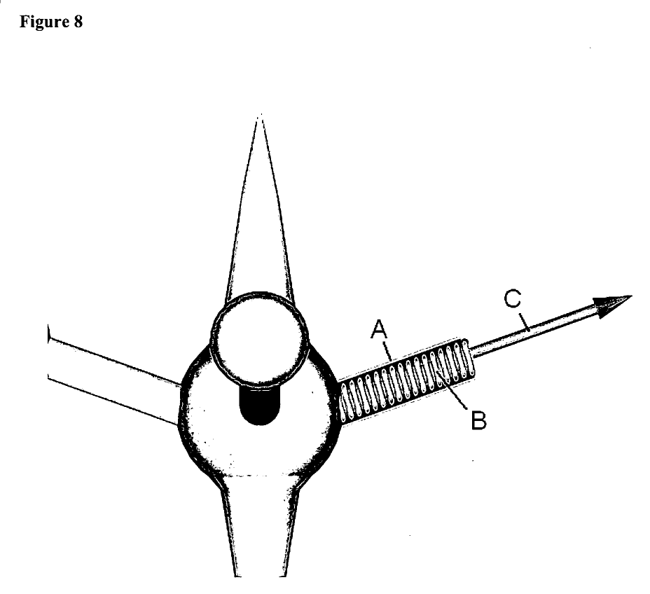

FIG. 9. Orthogonal vector components of magnetic field.

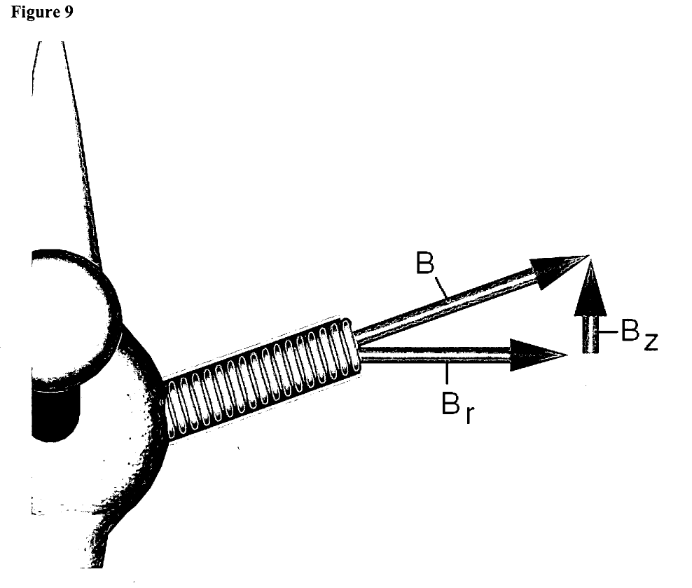

FIG. 10. Angular velocity of hull.

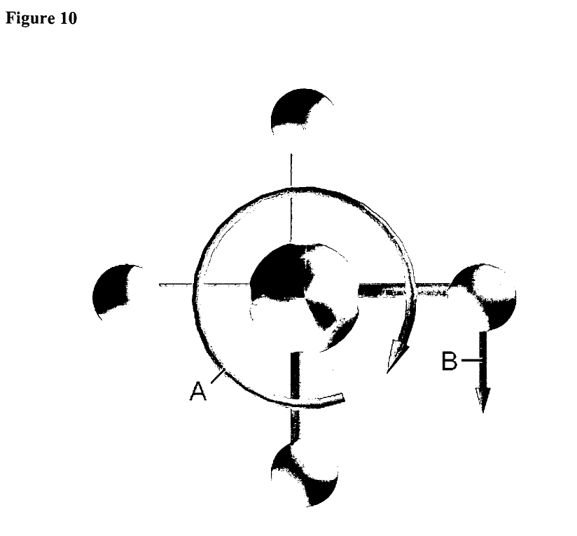

FIG. 11. Magnetic moment produced by radial electric dipole and sphere velocity.

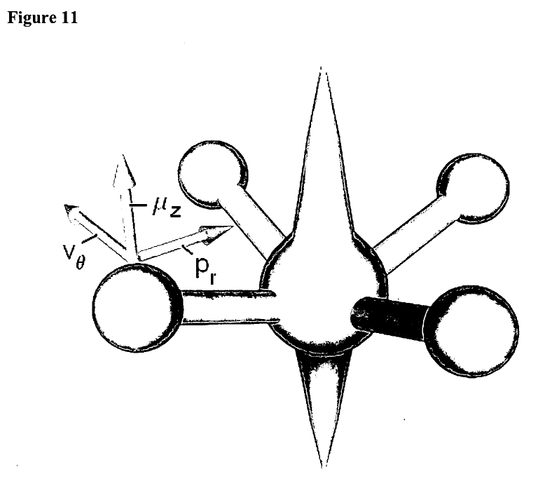

FIG. 12. Dot product of the magnetic moment with the magnetic field.

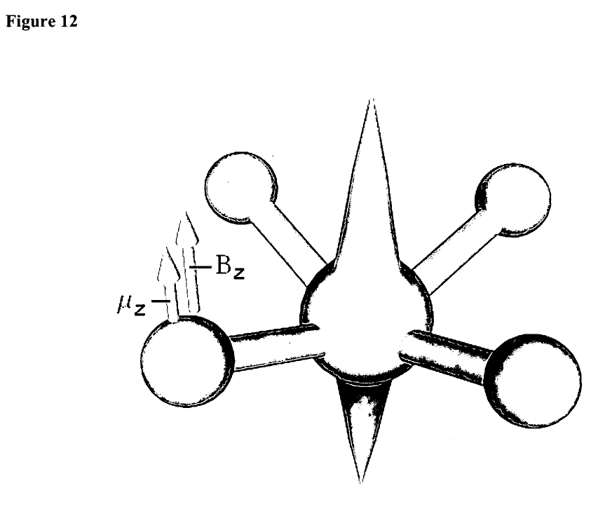

FIG. 13. Vertical lift force on all four conducting spheres.

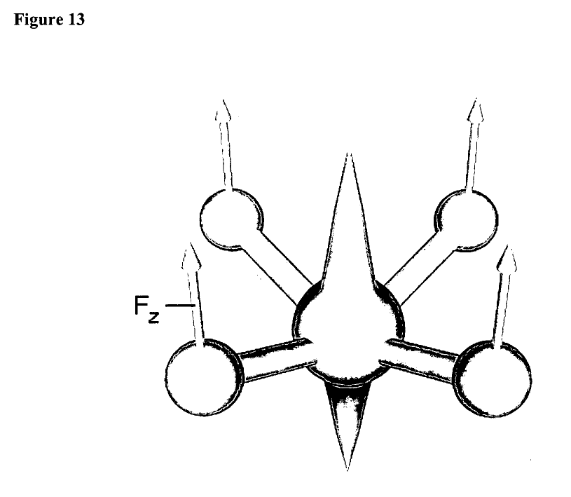

FIG. 14. Perpective view of spacecraft interior.

### DETAILED DESCRIPTION OF THE INVENTION

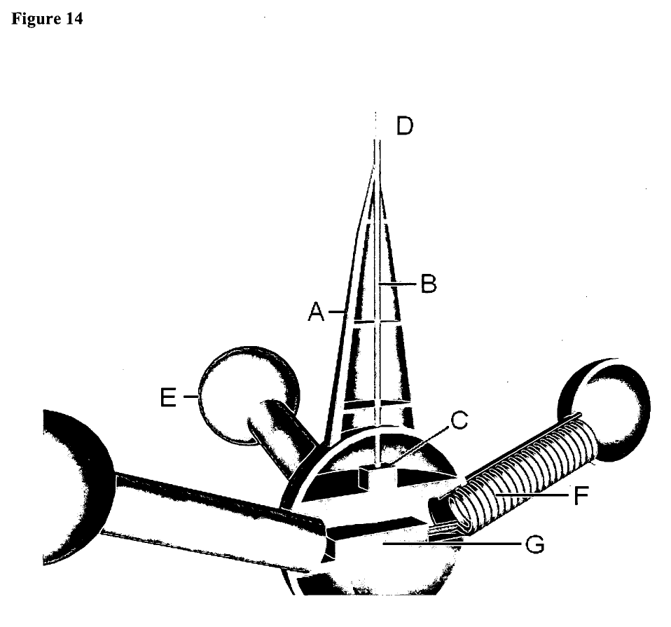

1. Referring to the cut-away view FIG. 14, the construction of the spacecraft is a thin-wall insulating thermoplastic having a dielectric constant in the range of 20 kilovolts per millimeter (A). An insulated electrode (B) runs from the cabin power supply and high-voltage transformer (C) to the tip of each tower (D). The four spheres (E) are silver plated to make them conducting. The tube solenoids (F) are driven by a direct current power supply (G).

2. The present model uses 3D computer design software and stereolithography fabrication techniques to create the thin-wall, low-weight, hollow structure of the hull. The computer model is sliced into many thin horizontal slices. A laser, mounted on an x-y table, draws out the slice on a table immersed in a bath of liquid polymer. Due to its sensitivity to the light, the liquid polymerizes. The table is then lowered a few thousandths of an inch more and the process is repeated. Thus making hollow spherical and conical shapes is extremely easy to do. Parts can be designed and stored in *.STL stereolithography files for transmission by Internet e-mail to the service bureau machine shop which sends the finished parts back the next day by express mail.

I claim:

1. A spacecraft comprising:
a. a spherical cabin;
b. an electrostatic conical tower mounted on top of item (1a), supporting a vertically-mounted negatively-charged insulated electrode at the tip of the tower;
c. an electrostatic conical tower mounted on the bottom of item (1a), supporting a vertically-mounted positively-charged insulated electrode at the tip of the tower;
d. a vertical electric dipole created by items (1b) and (1c);
e. a high-voltage transformer to drive item (1d), mounted in item (1a);
f. four tubular arms, mounted at 90° around and extending at an angle from item (1a);
g. four solenoids, each of which is mounted axially inside item (1f);
h. a direct current power supply to drive item (1g);
i. four silver-plated conducting spheres, each of which is mounted on the end of item (1f);

2. an electrostatic lift system that:
a. produces a uniform spherical electric field by means of item (1d) which envelopes item (1i);
b. produces a perturbed electric field due to the presence of item (1i);
c. produces an electric dipole moment in the direction of item (1b) due to items (2a) and (2b);
d. produces a vertical magnetic moment due to the clockwise angular velocity of item (1a) combined with item (2c);
e. produces a vertical lift force on item (1i) due to item (2d) combined with the magnetic field gradient in the vertical direction produced by item (1g); and
f. creates a motion control system by varying the current to item (1g) in order to increase or decrease the effect of item (2e) on a particular item (1i).
